(19) United States
(12) Patent Application Publication
(10) Pub. No.: US 2026/0258842 A1
(43) Pub. Date: Sep. 3, 2026

(54) SEALING RING, BEARING ASSEMBLY AND PRODUCTION METHOD

(71) Applicant: AKTIEBOLAGET SKF, GOTEBORG (SE)

(72) Inventors: Erich KLINGLMAIR, Niederneukirchen (AT); Helmut LANDERL, Steyr (AT); Florian KLOIBHOFER, Ardagger (AT)

(21) Appl. No.: 19/544,025

(22) Filed: Feb. 19, 2026

(30) Foreign Application Priority Data
Feb. 28, 2025 (DE) 102025107630.8

(51) Int. Cl. F16C 33/78

(52) U.S. Cl. CPC F16C 33/7823; F16C 33/7833; F16C 33/7856

(57) ABSTRACT

A sealing ring for separating an interior of a bearing from an exterior of the bearing, the sealing ring including an elastic sealing lip configured to extend into the interior of the bearing and run on a movable component of the bearing in a flexed state to keep a lubricant in the interior or the bearing. The elastic sealing lip has a first side configured to face into the interior of the bearing and a second side configurated to face the exterior of the bearing. The sealing lip includes at least one pressure equalization slot configured to allow air to pass from the interior of the bearing to the exterior of the bearing or from the exterior of the bearing to the interior of the bearing to equalize a pressure in the interior of the bearing and a pressure in the exterior of the bearing.

### CROSS-REFERENCE

This application claims priority to German patent application no. 10 2025 107 630.8 filed on February 28, 2025, the contents of which are fully incorporated herein by reference.

### TECHNOLOGICAL FIELD

The present disclosure relates to a sealing ring for a bearing assembly, to a method for producing such a sealing ring and to a bearing assembly having such a sealing ring.

### BACKGROUND

Known from the prior art are bearing assemblies which comprise one or a plurality of seal assemblies for sealing at least one bearing interior formed in the bearing assembly. This can prevent or at least reduce the leakage of grease from the bearing interior and preferably also the ingress of dirt into the bearing interior. During operation of the sealing arrangement, pressure differentials occur between the space thus sealed and an environment of the bearing assembly, for example due to temperature fluctuations. These lead to increased contact pressure forces and thus to significantly increased, harmful friction moments between an inner ring of the bearing and the seal resting thereon.

Seal assemblies having a pressure relief opening are known for equalizing the pressure differentials. DE 32 36 636 A1, for example, discloses a seal having an opening which is closed in the pressure chamber until a predetermined opening pressure is reached and which opens by way of deformation of the seal when the opening pressure is exceeded. This can prevent the occurrence of a harmful overpressure in the pressure chamber.

DE 10 2015 213 809 A1 discloses a machine assembly, in particular a rolling bearing having a seal assembly comprising two lips. The lips rest in each case on the machine assembly so as to rub against the latter, thus separating a closed space formed between the lips from an environment, or an interior of the machine assembly. At least one valve-like pressure equalization element, or even a pressure equalization element comprising a valve, in the seal assembly is used to equalize the pressure between the closed intermediate space and the environment, or between the closed intermediate space and the interior of the machine assembly.

Further state of the art is known from DE 37 41 084 C1 (family member: US 4,844,480), DE 10 2005 055 037 A1 (family member US 8,628,249) and DE 60 2005 006 202 T2.

### SUMMARY

An aspect of the present disclosure is to provide a sealing ring, a method for producing the sealing ring, and a bearing assembly by way of which adverse pressure fluctuations can be avoided.

A sealing ring according to the present disclosure serves to separate a bearing interior of a bearing assembly from the environment of the bearing. The bearing assembly can be configured in particular as a rolling bearing. The sealing ring comprises an elastically deformable sealing lip that is configured to rest on a movable component of the bearing assembly, in particular on a bearing inner ring, a bearing outer ring or a component connected to the bearing inner ring or the bearing outer ring.

In an installed state of this type, the sealing lip runs towards the bearing interior; in particular, the sealing lip can be angled from a flat region of the sealing ring towards the bearing interior. The sealing lip then, by way of one surface, delimits the bearing interior and, by way of an opposite surface, the bearing environment, in the process serving to suppress the leaking of lubricant from the bearing interior into the bearing environment. In cross section through the central axis of the sealing ring, the two surfaces can be formed to be straight and mutually parallel; in particular the sealing lip can advantageously have a uniform thickness (measured in the axial direction). According to special advantageous embodiments, the surfaces run along the surfaces of mutually coaxial cone surfaces.

The sealing lip has at least one pressure equalization slot through which air can enter in both directions, so that – depending on the particular situation – both a positive pressure and a negative pressure in the bearing interior can be matched to a prevailing pressure in the bearing environment.

As a "slot", such a pressure equalization slot has in particular an elongate shape. In its longitudinal direction, the slot can preferably run along a circumferential direction of the sealing ring; indications such as "circumferential direction", "radial" and "axial" and terms derived therefrom in this document always refer to a central axis of the sealing ring; in the envisaged installed state of the sealing ring in a bearing assembly, this central axis of the sealing ring corresponds to a central axis of the bearing assembly, in particular to the associated rotation axis of the bearing assembly.

A bearing assembly according to the disclosure comprises an inner ring, an outer ring and at least one sealing ring according to one embodiment of the present disclosure. The sealing ring separates an inner bearing of the bearing assembly from its bearing environment. In particular, the sealing ring is preferably installed in the manner envisaged, by way of its elastic sealing lip running towards the bearing interior thus resting on a component of the bearing assembly (e.g. the bearing inner ring, the bearing outer ring or a component connected to the bearing inner ring, or the bearing outer ring) that is movable (relative to the sealing ring), thus by way of the sealing lip keeping lubricant in the bearing interior.

The bi-directional pressure equalization able to be implemented according to the disclosure by at least one pressure equalization slot through which air can pass in both directions, avoids pressure differentials in the bearing assembly, such as can occur in particular by an increase in temperature and by subsequent cooling during the operation of the bearing assembly. An excessive increase in friction moments, which may result from pressure differentials of this type, can thus be prevented. In this way, the durability of the sealing ring and thus of the bearing assembly can be extended.

Due to its elongated shape, the at least one pressure equalization slot nevertheless advantageously retains grease in the bearing interior as well prevents dirt from entering into the bearing interior from the ambient environment.

In particular, the at least one pressure equalization slot can advantageously have a width which is at least one tenth or at least one ninth of a length of the at least one pressure equalization slot and/or which is at most half, at most one third or at most one quarter of the length. Size ratios of this type allow particularly advantageous compromise between the sealing characteristic on the one hand and the passage of air on the other.

At least one of the ends of at least one pressure equalization slot is preferably radiused. In particular, a border edge of the pressure equalization slot can comprise mutually opposite longitudinal sides which are connected to one another at the (at least one) corresponding end along a curve, in particular a portion of circular path. The longitudinal sides here can run in particular along mutually parallel straight line segments or concentric circles, for example. The radiusing on at least one end reduces edge loads, and this can prevent or at least reduce cracking that could occur during an elastic deformation of the sealing lip.

In a region of the at least one pressure equalization slot, the sealing ring, in particular its sealing lip, can be formed from an inhomogeneous material. Such inhomogeneity can be caused, for example, by local material compaction, in particular by merging of materials. The region can be formed, for example, as a seam around the pressure equalization slot. In particular, a/the material of the sealing ring can be inhomogeneous at a spacing of up to half or up to a third of a width of the slot.

The inhomogeneity in the material properties reduces deformation of the at least one pressure equalization slot during deformation of the sealing lip. Thus, the passage characteristics (including, e.g., size and shape) of the pressure equalization slot can be kept at least largely constant.

The inhomogeneity can be the result of heat input. In particular, it can preferably have been generated when generating the pressure equalization slots D by means of laser cutting. A method according to the disclosure for producing a sealing ring according to an embodiment of the present disclosure accordingly comprises incorporating the at least one pressure equalization slot (into a sealing ring blank) by means of a laser cutting device.

According to advantageous embodiments of the present disclosure, the sealing ring is configured to run on an axial end face of a component of the bearing assembly, specifically preferably in such a way that the at least one pressure equalization slot lies opposite the axial end face. The component can in particular be the bearing inner ring, the bearing outer ring or a component connected to the bearing inner ring or to the bearing outer ring.

In embodiments of this type, the disposal of the at least one pressure equalization slot opposite the end face minimizes a quantity of grease, which – forced in the axial direction in the bearing interior – reaches the pressure equalization slot. The at least one pressure equalization slot thus enables the pressure outlet to function while maintaining a high sealing quality of the sealing ring.

In particular, the inner ring of a bearing assembly according to the disclosure can preferably form a radially outward-facing shoulder surface, the radius thereof being larger than a spacing of the least one pressure equalization slot formed in the sealing ring from the central axis of the bearing assembly. A shoulder surface of this type may then be adjacent to one or a plurality of recess which is/are formed in the inner ring and in which rolling elements of the bearing assembly are disposed. With the specified ratio of radius and spacing, the at least one pressure equalization slot can thus be opposite an axial end face of the inner ring and thus be at least largely kept free in particular of grease which is displaced in the axial direction by the rolling elements.

In a relaxed (i.e. not elastically deformed) state of the sealing ring (in particular of the sealing lip), the at least one pressure equalization slot, preferably at least in a portion, narrows from an outside of the sealing ring that faces or is to face the bearing environment towards an opposite inside of the sealing ring that faces the bearing interior. A diameter of the pressure equalization slot (in particular its width) measured in the radial direction (in terms of the central axis of the sealing ring) thus decreases towards the bearing interior in such a portion.

Such a form of the at least one pressure equalization slot causes in the balanced (pressure-free) state an advantageously narrow pressure equalization slot and thus an advantageous sealing quality, whereas the pressure equalization slot is widened when the sealing lip is bent outwards due to increased pressure in the bearing interior. Thus, when the pressure inside the bearing is increased, a particularly effective, fast pressure equalization can be achieved.

Preferred exemplary embodiments of the disclosure will be explained in more detail hereunder by means of drawings. It goes without saying that individual elements and features can also be combined differently than illustrated. References for corresponding elements are used across figures and are potentially not described again for each figure.

### BRIEF DESCRIPTION OF THE DRAWINGS

FIG. 1A is an axial view of an exemplary embodiment of a sealing ring according to the disclosure.

FIG. 1B is a side sectional view of the sealing ring of FIG. 1A.

FIG. 2A is an axial view of an exemplary embodiment of a bearing assembly according to the disclosure.

FIG. 2B is a sectional view of the bearing assembly of FIG. 2A.

### DETAILED DESCRIPTION

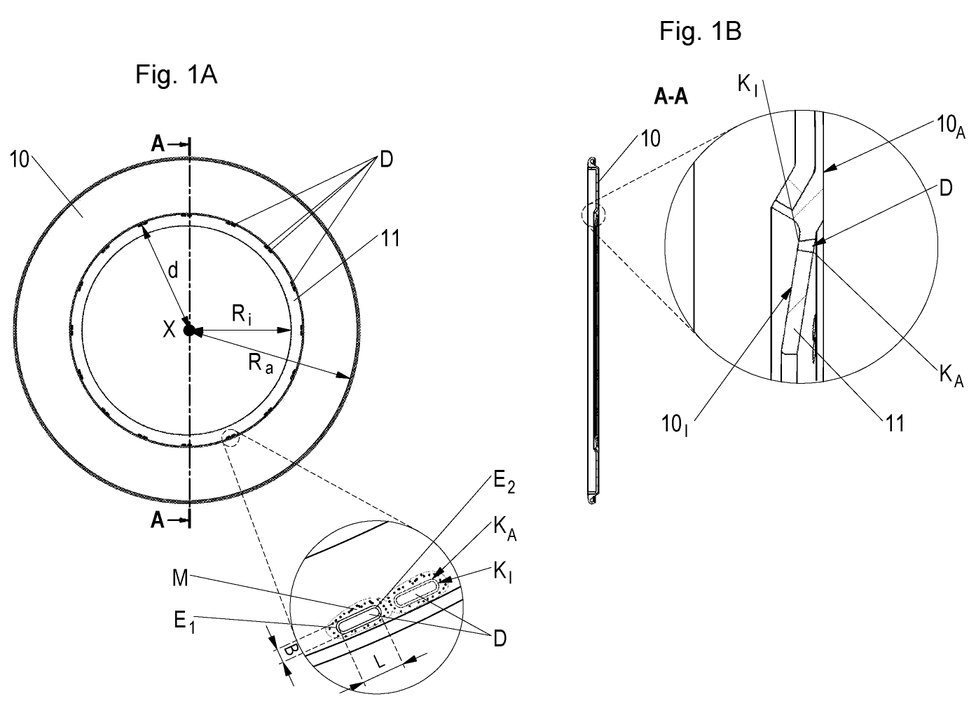

Shown in FIG. 1A is an embodiment of a sealing ring 10 according to the disclosure, viewed in the direction along its central axis X. FIG. 1B shows the sealing ring in the section A-A indicated in FIG. 1A.

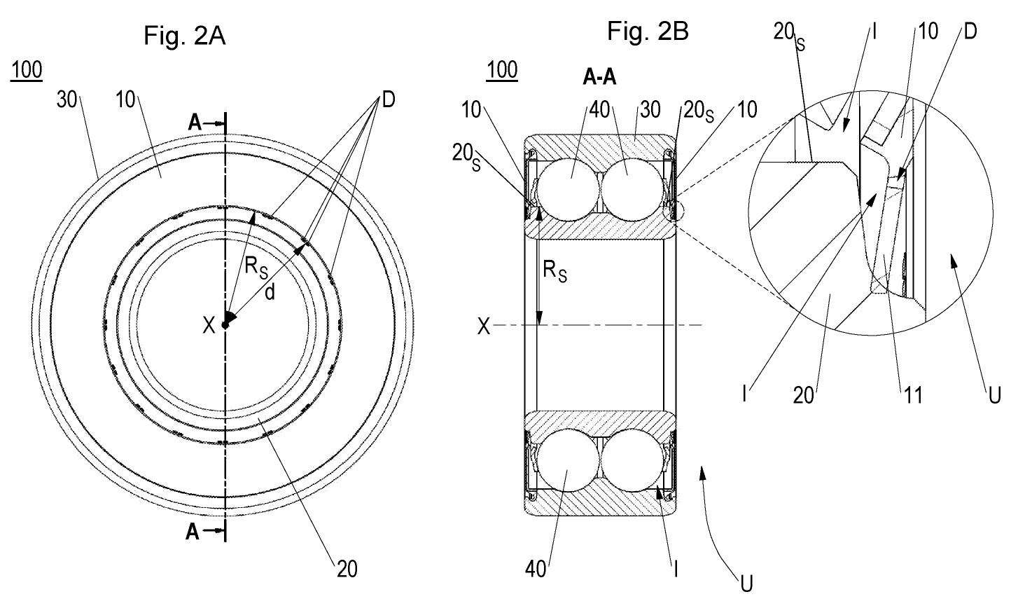

The sealing ring 10 comprises a sealing lip 11 which is configured to rest on an inner ring 20 of a bearing assembly 100, as illustrated in FIGS. 2A, 2B and described hereafter, and thus to separate a bearing interior I from a bearing environment U, in particular to prevent or at least minimize the leakage of grease from the bearing interior as well as the ingress of dirt into the bearing interior.

As can be seen in FIGS. 1A, 1B, the sealing ring 10 has a multiplicity of identically shaped pressure equalization slots D which extend in the circumferential direction at a spacing d from the central axis X.

Based on an external radius Rₐ and an internal radius Rᵢ of the sealing ring 10, in the illustrated advantageous embodiment d ≤ Rᵢ + (Rₐ – Rᵢ)/2, presently even d ≤ Rᵢ + (Rₐ – Rᵢ)/4, actually in this case even d ≤ Rᵢ + (Rₐ – Rᵢ)/5. The pressure equalization slots D are thus located in a radially innermost half, even a radially innermost quarter, presently actually even in a radially innermost fifth of the sealing ring 10. As can be derived from FIGS. 2A, 2B, an arrangement of the sealing ring 10 is thus possible in particular in such a manner that the pressure equalization slots D lie in a region in which no or at least almost no grease from rolling elements 40 of the bearing assembly 100 is forced into the pressure equalization slots D.

FIG. 1B shows in a detailed view one of the pressure equalization slots D in a radial section of the sealing ring 10. It can be seen here that the pressure equalization slots on an outside 10_{A} of the sealing ring 10 (which faces away from the interior of the bearing assembly when the sealing ring is disposed in a bearing assembly as intended) is delimited by an edge K_{A}, and on an inside 10_{I} of the sealing ring (which faces the bearing interior of the bearing assembly when the sealing ring is disposed in a bearing assembly as intended) is delimited by an edge K_{I}. In the relaxed state of the sealing ring 10 shown, the pressure equalization slot D narrows in the direction of the outside 10_{A} to the inside 10_{I}, the edge K_{I} is therefore narrower than the edge K_{A}, as is also shown in the detail view of FIG. 1A.

The shape of the pressure equalization slot, which thus narrows in the axial direction, widens when the sealing lip 11 is bent outwards due to the increased pressure prevalent in the bearing interior. Thus, when the pressure inside the bearing is increased, a particularly effective, fast pressure equalization can be achieved, whereas the pressure equalization slot D allows a more gentle pressure equalization (in the other direction) at a lower pressure in the bearing interior compared to the environment; however, due to its reduced size, the ingress of dirt into the bearing interior is prevented or at least minimized.

As can furthermore be seen in the detailed view of FIG. 1A, the slot-shaped pressure equalization slots D in the embodiment illustrated each have a length L measured in the circumferential direction and a width B. In the example illustrated, the length L is approximately four times the width B. Owing to this narrow elongate shape, a particularly reliable pressure equalization in both directions through the slots can be guaranteed, while nevertheless preventing or at least minimizing an escape of grease from the bearing interior, on the one hand, and an ingress of dirt into the bearing interior, on the other hand.

At their ends E₁, E₂,, the slot-shaped pressure equalization slots D are each radiused (along a surface that is to face the bearing interior as well as along a surface of the sealing lip 11 that faces or is to face the bearing environment). This may reduce loads and prevents the occurrence of cracks during deformation of the sealing lip 11.

In the embodiment shown, the pressure equalization slots D are evenly distributed in (presently 16) pairs about the central axis X. In the circumferential direction, a spacing between two pressure equalization slots D of each pair is smaller than the length L, presently even less than half the length L. Thus, an advantageous increased flexibility of the sealing lip 11 in the region of the pressure equalization slots D is achieved. Between each two adjacent pairs lies a pressure equalization slot-free arc at a spacing d from the central axis X, the arc length thereof presently being larger than 4L. This results in an advantageously high stability and durability of the sealing ring.

In a peripheral region M of the pressure equalization slots D, the material of the sealing ring 10 can advantageously be formed inhomogeneously, for example in terms of its density. This is shown schematically in the detail view of FIG. 1A by dots symbolizing local material compaction. The inhomogeneity can be in particular be a result of heat input, for example, it can preferably have been generated when generating the pressure equalization slots D by means of laser cutting.

In FIGS. 2A and 2B, a bearing assembly 100 according to an exemplary embodiment of the present disclosure is shown. In FIG. 2A, the bearing assembly 100 is shown when viewed in the direction along the central axis X. FIG. 2B shows the bearing assembly 100 in the section A-A indicated in FIG. 2A.

The bearing assembly 100 comprises an inner ring 20 and an outer ring 30, between which a plurality of rolling elements (in particular balls) 40 are disposed in a bearing interior I. In the axial direction, the bearing interior I is sealed on both sides from a bearing environment U by a sealing ring 10 in each case, as shown in FIGS. 1A, 1B and described above.

Each sealing ring 10 connects the outer ring 30 to the inner ring 20 and – as can be seen in particular in the detailed view of FIG. 2B – by way of its respective sealing lip 11 runs onto one of the two axial end faces F of the bearing assembly, here of the inner ring 20.

Here, the sealing lip 11 delimits the bearing interior I on one side by way of an annular surface and on the other side, by way of its opposite annular surface, the bearing environment U. In the cross section shown, the annular surfaces are presently straight and mutually parallel. In particular, they can run along coaxial conical surfaces about the central axis X.

In the exemplary embodiment shown in FIGS. 2A, 2B, the inner ring 20 forms at each of its axial ends a shoulder surface running along a cylinder surface 20S. A radius RS of this cylinder, i.e. a spacing of the shoulder surface 20S from the central axis X, is larger than the spacing d at which the pressure equalization slots D are disposed from the central axis X. The pressure equalization slots D therefore lie opposite the frontal face of the shoulder surface 20S and are thus located in a region in which no or at least almost no grease is forced axially from the rolling elements 40 of the bearing assembly 100 into the pressure equalization slots D. Thus, contamination or even blockage of the pressure equalization slots D can be at least largely avoided.

Disclosed is a sealing ring 10 for separating a bearing interior I of a bearing assembly 100 from its bearing environment U. The sealing ring 10 comprises an elastic sealing lip 11 for resting on a component of the bearing assembly 100 that is movable relative to the sealing ring 20 in such a manner that the sealing lip runs towards the bearing interior and in the process serves to keep lubricant in the bearing interior I. The sealing lip 11 has at least one pressure equalization slot D which enables air to pass in both directions.

Furthermore disclosed are a method for producing a sealing ring 10 of this type, and a bearing assembly 100 having an inner ring, an outer ring and at least one such sealing ring 10.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sealing rings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### List of reference signs

10 Sealing ring

10_{A} Outside of the sealing ring

10_{I} Inside of the sealing ring

11 Sealing lip

20 Inner ring

20_{S} Shoulder surface of inner ring

30 Outer ring

40 Rolling element

100 Bearing assembly

B Width of the pressure equalization slots D

d Distance of the pressure equalization slots D from the central axis X

D Pressure equalization slot

E₁, E₂ End of a pressure equalization slot D

L Length of the pressure equalization slots D

I Bearing interior

K_{A} Edge of a pressure equalization slot D on the outside 10_{A} of the sealing ring

K_{I} Edge of a pressure equalization slot D on the inside 10_{I} of the sealing ring

M Edge of a pressure equalization slot D

Rₐ External radius of the sealing ring

Rᵢ Internal radius of the sealing ring

R_{S} Radius of shoulder surface 20_{S} of inner ring

What is claimed is:

1. A sealing ring for separating an interior of a bearing from an exterior of the bearing, the sealing ring comprising:
an elastic sealing lip configured to extend into the interior of the bearing and run on a movable component of the bearing in a flexed state to keep a lubricant in the interior or the bearing, the elastic sealing lip having a first side configured to face into the interior of the bearing and a second side configurated to face the exterior of the bearing,
wherein the sealing lip includes at least one pressure equalization slot configured to allow air to pass from the interior of the bearing to the exterior of the bearing or from the exterior of the bearing to the interior of the bearing to equalize a pressure in the interior of the bearing and a pressure in the exterior of the bearing.

2. The sealing ring according to claim 1,
wherein, in an unflexed state of the elastic sealing lip the at least one pressure equalization slot narrows in a direction from the second side toward the first side.

3. The sealing ring according to one of claim 2,
wherein the at least one pressure equalization slot comprises a plurality of pressure equalization slots disposed circumferentially around the sealing ring,
wherein each of the pressure equalization slots has a closed periphery, and
wherein a length direction of each of the pressure equalization slots extends circumferentially.

4. The sealing ring according to claim 3,
wherein at least one end of each of the plurality of pressure equalization slots is radiused.

5. The sealing ring according to claim 4,
wherein the at least one pressure equalization slot has a width,
wherein the width is at least one tenth of a length of the at least one pressure equalization slot, and/or
wherein the width is at most one quarter of the length of the at least one pressure equalization slot.

6. The sealing ring according to claim 4,
wherein the sealing lip is configured to run on an axial end face of a component of the bearing assembly in such a manner that the at least one pressure equalization slot opposes the axial end face.

7. The sealing ring according to one of the claim 1,
wherein a composition and/or density of a material immediately surrounding the at least one pressure equalization slot is different than a material of a remainder of the sealing lip.

88. The sealing ring according to one of the claim 7,
wherein the material immediately surrounding the at least one pressure equalization slot comprises a respective continuous ring of material surrounding each of the at least one pressure equalization slot and having a width up to one half of a width of the at least one pressure equalization slot.

9. The sealing ring according to one of the claim 8,
wherein the at least one pressure equalization slot is laser cut.

10. The sealing ring according to one of the claim 1,
wherein the at least one pressure equalization slot is laser cut.

11. A bearing assembly comprising:
an inner ring,
an outer ring and
at least one sealing ring according to claim 1 mounted between the inner ring and the outer ring to separate an interior of the bearing assembly from an exterior of the bearing environment.

12. The bearing assembly according to claim 11,
wherein the inner ring has a radially outward-facing shoulder surface,
wherein a radius of the shoulder surface is larger than a spacing of the at least one pressure equalization slot from a central axis of the bearing assembly.

13. The bearing assembly according to claim 11,
wherein the at least one pressure equalization slot faces an axial end face of a component of the bearing assembly.

14. A method for producing a sealing ring for separating an interior of a bearing from an exterior of the bearing, the sealing ring comprising:
an elastic sealing lip configured to extend into the interior of the bearing and run on a movable component of the bearing in a flexed state to keep a lubricant in the interior or the bearing, the elastic sealing lip having a first side configured to face into the interior of the bearing and a second side configurated to face the exterior of the bearing,
the method comprising:
laser cutting at least one pressure equalization slot in the elastic seal lip to form a pressure equalization slot.

15. The method according to claim 14,
wherein the laser cutting at least one pressure equalization slot in the elastic seal lip changes a density of a material immediately surrounding the at least one pressure equalization slot.
